(19) United States
(12) Patent Application Publication
(10) Pub. No.: US 2016/0277100 A1
(43) Pub. Date: Sep. 22, 2016

(54) METHOD AND APPARATUS FOR TESTING OPTICAL FIBER IN OPTICAL DISTRIBUTION NETWORK

(71) Applicant: Electronics and Telecommunications Research Institute, Daejeon (KR)

(72) Inventors: Yongseok YOO, Gwangju (KR); Sung Chang KIM, Gwangju (KR); Dongsoo LEE, Seongnam-si (KR)

(73) Assignee: Electronics and Telecommunications Research Institute, Daejeon (KR)

(21) Appl. No.: 15/070,390

(22) Filed: Mar. 15, 2016

(30) Foreign Application Priority Data
Mar. 17, 2015 (KR) 10-2015-0036860

(51) Int. Cl. H04B 10/071; H04Q 11/00; H04B 10/079

(52) U.S. Cl. CPC H04B 10/071; H04B 10/0793; H04Q 11/0067; H04Q 2011/0083

(57) ABSTRACT

Provided is an apparatus for testing an optical fiber in an optical distribution network, the apparatus being capable of synthetically testing an optical fiber by using a plurality of optical pulse signals. The apparatus includes a transmitter configured to transmit a first and a second optical pulse signal to an optical fiber connected to optical network units (ONU) through a coupler, and a receiver configured to receive, from the coupler, a first received optical pulse signal and a second received optical pulse signal The apparatus includes an analog to digital (A/D) converter configured to generate first and second received optical signals according to received intensities of the first and second received optical pulse signals to convert the first and second received optical signals into first and second digital received optical data, and a processor configured to process the first and second digital received optical data to generate a scale domain response to perform image visualization and optical fiber state analysis to monitor the optical fiber.

### CROSS-REFERENCE TO RELATED APPLICATIONS

This U.S. non-provisional patent application claims priority under 35 U.S.C. §119 of Korean Patent Application No. 10-2015-0036860, filed on Mar. 17, 2015, the entire contents of which are hereby incorporated by reference.

### BACKGROUND

The present disclosure herein relates to an optical distribution network field for optical communication, and more particularly, to a method and apparatus for testing the test of an optical fiber in an optical distribution network.

A movement to broadband communication networks is being actively performed due to an explosive increase in data traffic, and to this end, typical copper wire based communication networks are replaced with optical fiber based optical distribution networks.

Since maintenance cost for the optical distribution networks that rapidly increase approaches about 40% of the total cost, it becomes a significant burden to carriers. Thus, there is an urgent need for a technology to effectively manage the optical distribution networks.

### SUMMARY

An exemplary embodiment of the inventive concept provides a method of testing an optical fiber in an optical distribution network, the method including: transmitting, as monitoring light signals, a first optical pulse signal that has a first pulse width and a second optical pulse signal that has a second pulse width, to an optical fiber connected to optical network units (ONU); receiving a first received optical pulse signal and a second received optical pulse signal that are reflected through the optical fiber; generating first and second received optical signals according to received intensities of the first and second received optical pulse signals and then converting the generated signals into first and second digital received optical data; and processing the first and second digital received optical data to synthetically visualize or analyze optical pulse signals received with a plurality of scales to monitor the optical fiber.

In an exemplary embodiment, the first pulse width may be wider or narrower than the second pulse width, and the first optical pulse signal and the second optical pulse signal may be transmitted at different times.

In an exemplary embodiment, the first optical pulse signal and the second optical pulse signal may be generated by pulse width modulation through a single optical pulse generator, the first optical pulse signal and the second optical pulse signal may be exclusively generated by different optical pulse generators, respectively, and the visualization may include aligning the first and second digital received optical data in a y-axis direction that represents a pulse width, to display the data as a 2D image in a triangle pattern.

In an exemplary embodiment of the inventive concept, an apparatus for testing an optical fiber in an optical distribution network, the apparatus including: a transmitter configured to transmit, as monitoring light signals, a first optical pulse signal that has a first pulse width and a second optical pulse signal that has a second pulse width, to an optical fiber connected to optical network units (ONU) through a coupler; a receiver configured to receive, from the coupler, a first received optical pulse signal and a second received optical pulse signal that are reflected through the optical fiber, and to generate first and second received optical signals according to received intensities of the first and second received optical pulse signals; an analog to digital (A/D) converter configured to convert the first and second received optical signals into first and second digital received optical data; and a processor configured to process the first and second digital received optical data to generate a scale domain response for image visualization to monitor the optical fiber.

In an exemplary embodiment of the inventive concept, a method of testing an optical fiber in an optical distribution network, the method including: transmitting, as monitoring light signals, a plurality of optical pulse signals that has different pulse widths, to an optical fiber connected to optical network units (ONU); generating a plurality of received optical signals that correspond to received intensities of a plurality of received optical pulse signals reflected through the optical fiber, and then converting the generated signals into digital received optical data; processing the digital received optical data to generate a scale domain response for image visualization and optical fiber state analysis; detecting vertical edges that are perpendicular to a time axis and slanted edges from patterns of the generated scale domain response, to identify signals corresponding to adjacent points on the optical fiber, even in a case where the scale domain response is restrictively generated; and matching and analyzing the vertical edges and the slanted edges correspondingly on the time axis to determine whether the received signals corresponds to a single point or a plurality of points on the optical fiber.

In an exemplary embodiment, it may be determined that a straight line of the vertical edge and a straight line of the slanted edge correspond to a single point on the optical fiber, if the slanted edge corresponding to the vertical edge meets at a single point on the time axis when matching the vertical edges and the slanted edges on the time axis.

In an exemplary embodiment, it may be determined that a straight line of the vertical edge and a straight line of the slanted edge correspond to different points on the optical fiber, if the slanted edge corresponding to the vertical edge does not meet at a single point on the time axis when matching the vertical edges and the slanted edges on the time axis.

In an exemplary embodiment of the inventive concept, an apparatus for testing an optical fiber in an optical distribution network, the apparatus including: a transmitter configured to transmit, as monitoring light signals, a plurality of optical pulse signals that has different pulse widths, to an optical fiber connected to optical network units (ONU) through a coupler; a receiver configured to receive, from the ONU, a plurality of received optical pulse signals reflected through the optical fiber and generate received optical signals that correspond to received intensities of the plurality of received optical pulse signals; an analog to digital (A/D) converter configured to convert the received optical signals into digital received optical data; and a controller configured to process the digital received optical data to generate a scale domain response for image visualization to monitor the optical fiber, and identify signals corresponding to adjacent points on the optical fiber in a case where the scale domain response is restrictively generated.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is an illustration of an optical fiber test concept using general optical time-domain reflectometer (OTDR);

FIGS. 2A and 2B are diagrams that show a wave-form characteristic according to a change in width of an optical pulse signal;

FIG. 3 is a block diagram of an optical fiber test apparatus in an optical distribution network according to an exemplary embodiment of the inventive concept;

FIG. 4 shows an example of optical fiber monitoring visualization of an optical fiber test according to FIG. 3;

FIG. 5 is a diagram that emphasizes a visualization pattern in FIG. 4 and is presented in order to explain a principle in which automatic monitoring may be performed;

FIG. 6 is a diagram presented in order to explain a principle in which an optical fiber monitoring resolution increases even in the case where a pulse width is restricted; and

FIG. 7 is an optical fiber monitoring resolution improvement flowchart according to an exemplary embodiment of the inventive concept.

### DETAILED DESCRIPTION

The above objectives, other objectives, characteristics and advantages of the inventive concept will be easily understood through the following embodiments to be described with reference to the accompanying drawings. Therefore, the inventive concept is not limited to embodiments to be described below but may be implemented in other forms. Rather, embodiments introduced herein are provided to make the disclosed contents more thorough and complete and to fully convey the spirit of the inventive concept to a person skilled in the art, without other intents except for providing the convenience of understanding.

When the present disclosure mentions that any elements or lines are connected to target element blocks, it does include not only a direct connection but also an indirect connection meaning that the elements are connected to the target element blocks through some other elements.

Also, the same or similar reference numerals presented in each drawing represent the same or similar components if possible. In some drawings, the connection of elements and lines is only represented for the effective description of the technical contents, and other elements or circuit blocks may be further included.

It should be noted that each embodiment described and illustrated herein may also include its complementary embodiment but the details of the general operations of optical communication equipment or of the internal function circuits of an optical distribution network are not described in detail in order not to obscure the subject of the inventive concept.

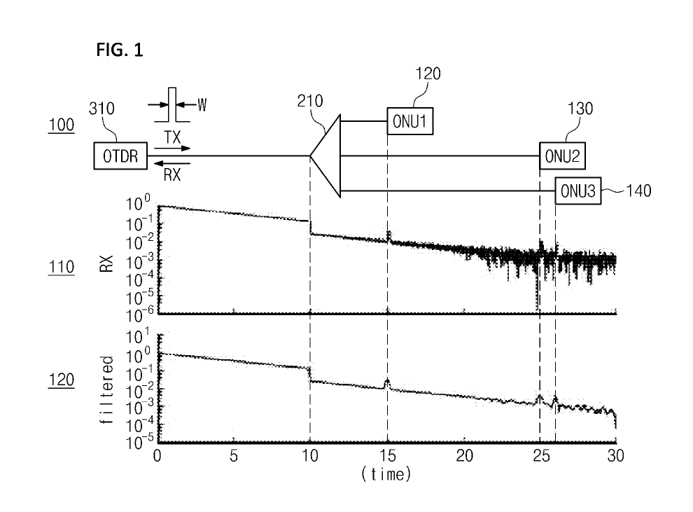

FIG. 1 is an illustration of an optical fiber test concept using general optical time-domain reflectometer (OTDR).

Referring to reference numeral 100 in FIG. 1, the OTDR 310 is connected to an optical power distributor 210 through an optical fiber. The optical power distributor 210 is connected to a plurality of optical network units (ONU) 120, 130, and 140 that are referred to as residential optical network terminals, to perform optical power distribution.

The OTDR 310 transmits a specific form of optical pulse signal through an optical fiber to be tested and then measures a reflected optical pulse signal to test whether the optical fiber has an error.

FIG. 1 represents an example of testing a passive optical network (PON) connected to the plurality of ONUs by using a single OTDR 310.

Values obtained by the measuring of a plurality of reflected optical pulse signals RX according to a time with respect to an optical pulse signal TX that has a pulse width w may follow the waveform represented by reference numeral 100 in FIG. 1. In graphs in FIG. 1, the horizontal axis indicates time and the vertical axis indicates the intensity of a signal.

Times (e.g., 15 μsec, 25 μsec, 26 μsec) at which the measured optical pulse signals discontinuously vary may have a proportional relation with the distance from the OTDR 310 to a network node in an actual space. Thus, when detecting discontinuous points on the measured signal, it is possible to find the position of a node in a space or of a wrong point. To this end, when passing a waveform corresponding to reference numeral 110 through a matched filter that finds the correlation between a transmitted pulse and a received signal, the filtered wavelength as represented by reference numeral 120 in FIG. 1 is obtained consequently. As such, the optical signal test using the OTDR may be generally performed through a way of finding the local maxima of the filtered value.

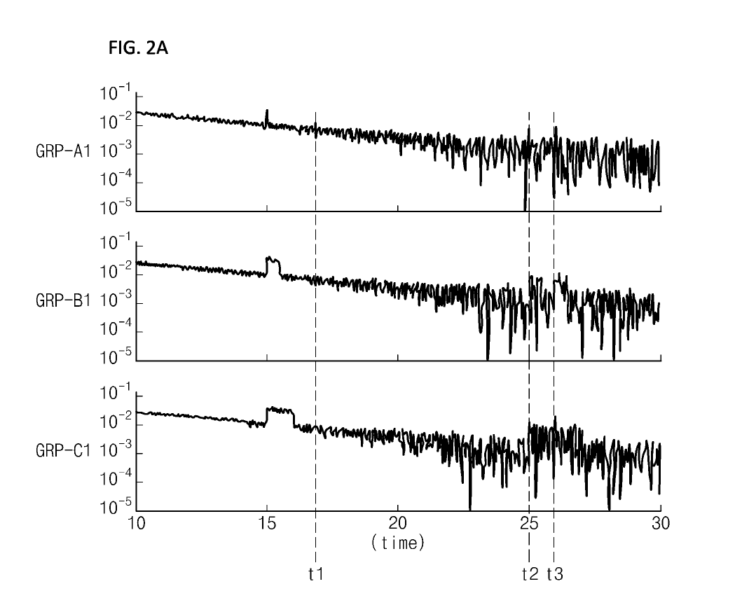

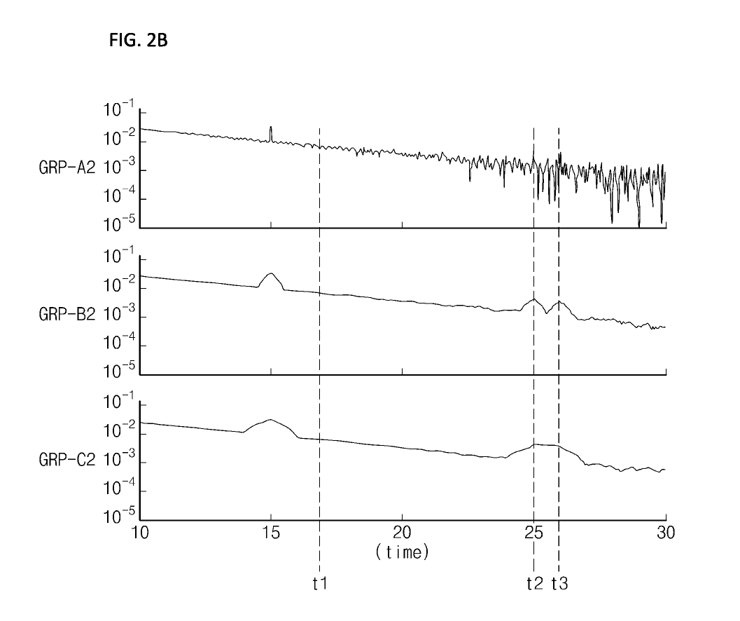

Upon the optical fiver test using the OTDR, the reliability of the optical fiber test may significantly vary according to the shape of a transmitted optical pulse signal. The most important factor among many factors that affect the reliability is an optical pulse signal width (PW) w. That is, when the PW increases, it is possible to transmit more energy through a single optical pulse signal and thus it is possible to obtain a higher signal to noise ratio (SNR) as shown in FIGS. 2A and 2B.

FIGS. 2A and 2B are diagrams that show a wave-form characteristic according to a change in width of an optical pulse signal. On graphs in FIGS. 2A and 2B, the horizontal axes indicate time and the vertical axes indicate the intensity of a signal. FIG. 2A indicates the waveforms measured on a reflected optical pulse signal, and FIG. 2B correspondingly represents filtered waveforms that are obtained by the filtering of the waveforms in FIG. 2A through the matched filter.

As could be seen through FIGS. 2A and 2B, when the width w of the PW gradually increases, it is difficult to detect neighboring optical pulse signals and thus an adverse effect of decreasing spatial resolution may occur. That is, even in FIG. 2B, the signal identification between times t2 and t3 on graph GRP-C2 that has the largest pulse width is relatively more difficult than the signal identification between times t2 and t3 on graph GRP-A2 that has the smallest pulse width.

Thus, in order to monitor an optical fiber using the OTDR, there is a need to use a PW suitable for the characteristic of an optical distribution network to be tested. Typical methods of finding an optimal PW may be classified into the following three methods.

Firstly, a user sets the PW for himself and secondly, values publicly known according to the length of an optical fiber to be tested are set as the PW. Thirdly, the PW is adaptively set by the analysis of returned reflected light.

The drawbacks of the first method are that a test result depends significantly on the experience and skill of the user and a time taken to test the optical fiber increases according to trial and error by a user input.

The limit of the second and third methods is that it is possible to test only a specific position of a single optical fiber in a single test. Eventually, there is a limitation in that a lot of time is spent in order to test the whole optical fibers. Especially, in the third method, further hardware and software are needed in order to find an optimal PW. Also, since test equipment is complicated, implementation costs increase.

The fundamental limit of the OTDR developed so far is that it is difficult to apply the OTDR to a passive optical network. In the passive optical network, optical signals are transmitted to many ONUs through an optical splitter, in which case there is a significant loss in energy. Also, there are many cases where many ONUs have a similar position. Thus, in order to monitor the passive optical network, relatively high spatial resolution is needed even in a situation in which a SNR is significantly low.

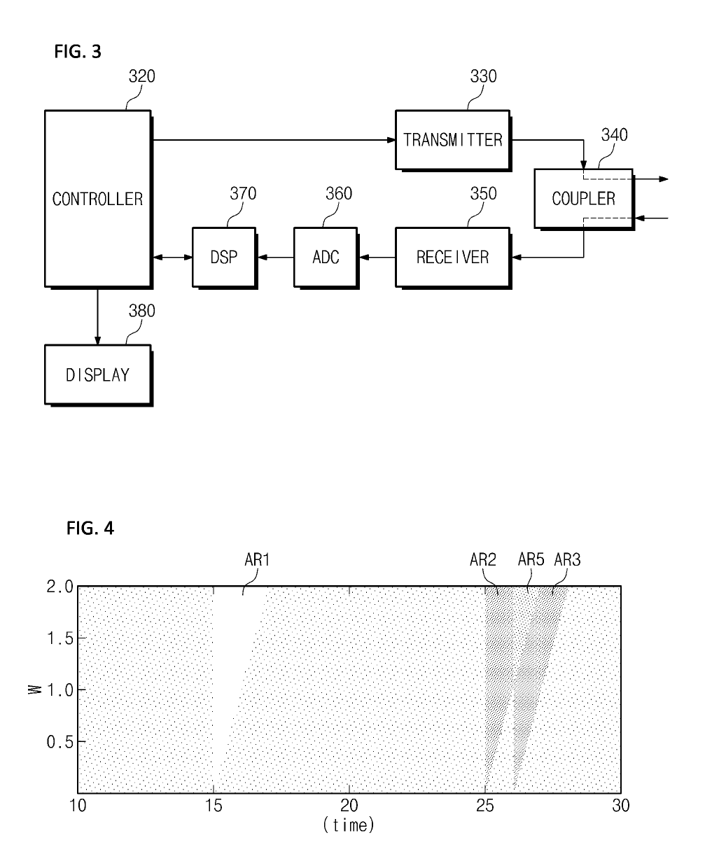

The inventive concept has the configuration of an embodiment in FIG. 3 and thus solves the limitations or drawbacks of the typical optical fiber detection method as described above.

FIG. 3 is a block diagram of an optical fiber test apparatus in an optical distribution network according to an exemplary embodiment of the inventive concept.

Referring to FIG. 3, the optical fiber test apparatus includes a controller 320, a transmitter 330, a coupler 340, a receiver 350, an analog to digital converter (ADC) 360, a digital signal processor (DSP) 370, and a display 380.

The coupler 340 transmits transmitted optical pulse signals to an optical fiber and couples reflected received optical pulse signals to provide the coupled signals to the receiver 350.

The transmitter 330 transmits, as monitoring light signals, a first optical pulse signal that has a first pulse width and a second optical pulse signal that has a second pulse width, to the ONUs or optical fibers connected to the ONUs through the coupler 340. The transmitter 330 may internally include a single optical pulse generator to generate the first optical pulse signal and the second optical pulse signal by pulse width modulation. Alternatively, the transmitter 330 may internally include a plurality of optical pulse generators to exclusively generate the first optical pulse signal and the second optical pulse signal through different optical pulse generators, respectively. The transmitter 330 may be controlled by the controller 320. That is, the controller 320 may control the transmitter 330 to adjust the width of a transmitted optical pulse signal.

The receiver 350 receives, from the coupler 340, a first received optical pulse signal and a second received optical pulse signal that are reflected through the optical fiber, and generates first and second received optical signals according to the received intensities of the first and second received optical pulse signals. The receiver 350 receives at least two received optical pulse signals that are reflected through the optical fiber. The receiver 350 is made up of one or more photo diodes to generate received optical signals that are electrical signals, according to the received intensities of the optical pulse signals.

The A/D converter 360 that is the ADC converts the first and second received optical signals into first and second digital received optical data.

The DSP 370 processes the first and second digital received optical data in order to monitor the optical fiber and generates a scale domain response for image visualization or automatic monitoring analysis. The DSP 370 exclusively processes the first and second digital received optical data and performs data communication with the controller 320.

The controller 320 may be connected to the display 380, such as a liquid crystal display that shows image visualization. An optical fiber test result that is obtained by the aggregate processing of the first and second digital received optical data is transmitted from the DSP 370 to the controller 320 and output through the display 380. Alternatively, the controller 320 may also perform a preset program solely without depending on the functions of the DSP 370 to perform control for an optical fiber test.

The scale domain response may include aligning the first and second digital received optical data in the y-axis direction representing a pulse width to display the data as a 2D image in a right-angled triangle pattern.

Eventually, the test apparatus in FIG. 3 does not use an optical pulse signal having a single set pulse width to test the optical fiber but uses a plurality of optical pulse signals having different pulse widths to synthetically test the optical fiber. In addition, the test apparatus in FIG. 3 may provide image patterns as shown in FIG. 4 to provide added convenience of interpretation on the optical fiber test to a user.

FIG. 4 shows an example of optical fiber monitoring visualization of an optical fiber test according to FIG. 3. In FIG. 4, the horizontal axis represents time and the vertical axis represents a pulse width.

Referring to FIG. 4, three 2D image patterns are shown on different time axes. A single 2D image pattern AR1 that has a right-angled triangle shape corresponds to a plurality of received optical pulse signals that is reflected through an optical fiber. That is, a single received optical pulse signal that is reflected with respect to a single optical pulse signal having a PW w is represented by a single horizontal line when the signal is displayed as the 2D image. Another received optical pulse signal that is reflected with respect to another optical pulse signal is represented by another horizontal line when the signal is displayed as the 2D image. These horizontal lines gather so that the 2D image pattern AR1 is formed on the display 380 in FIG. 3. Eventually, when measurement values for different PWs w are aligned in the y-axis direction, the 2D image in the right-angled triangle pattern is represented. Adjacent 2D image patterns AR2 and AR3 may have an overlapping region AR5.

In FIG. 4, the 2D image pattern AR1 is relatively great in intensity of a received optical pulse signal in comparison to the 2D image patterns AR2 and AR3. An optical pulse signal that is reflected from a point relatively close to the coupler 340 is great in intensity in comparison to an optical pulse signal that is reflected from a further point.

The 2D image patterns that have the right-angled triangle shape generated in this way correspond to the positions of ONUs in a space, respectively. The image obtained in this way is referred to a scale domain response, and a technique of monitoring the characteristic of an optical fiber in different scales is referred to as optical scale domain reflectometry.

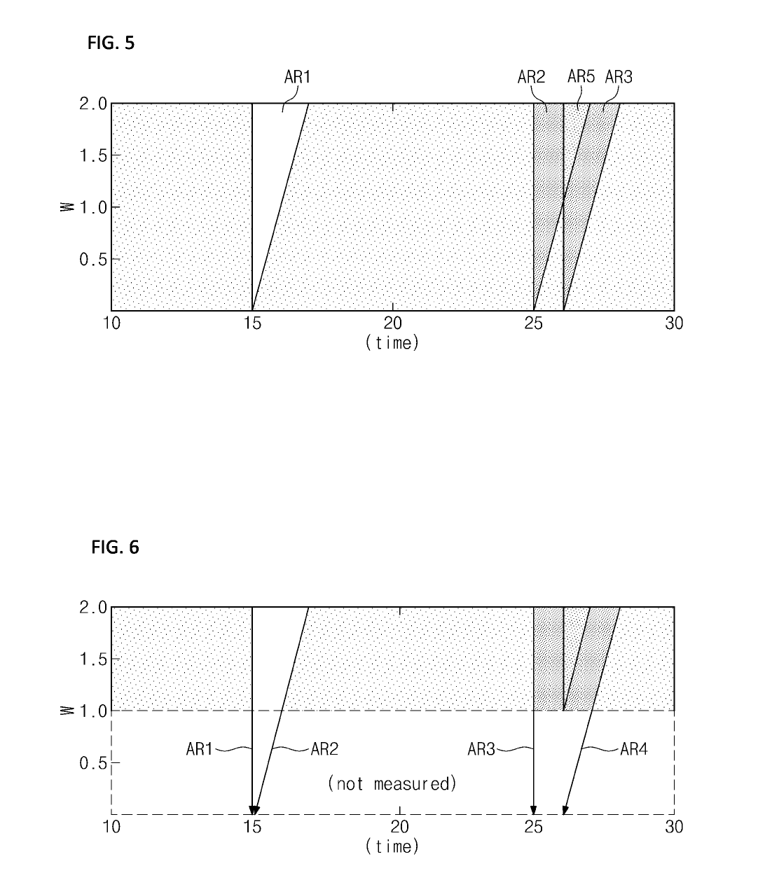

FIG. 5 is a diagram that emphasizes a visualization pattern in FIG. 4 and is presented in order to explain a principle in which automatic monitoring may be performed.

The scale domain response displayed in FIGS. 4 and 5 may be interpreted as follows. When there is a change at a specific point on an optical fiber, the change represents a triangle-shaped pattern in the scale domain response. When a point where the triangle and the time axis meet is found, it is possible to calculate a position where there is a corresponding change. For example, light triangles that are placed at t=15 in FIGS. 4 and 5 correspond to changes in a single point on an optical fiber. By the same principle, triangle patterns corresponding to two points on an optical fiber that correspond to time=25 and t=26 are shown in the scale domain response. When the two points are close to each other, corresponding two triangles appear to overlap.

By the principle above, optical fiber monitoring may be completely automated when a right-angled triangle pattern is detected from the scale domain response even without a user input or separate interpretation and then the position of the vertex of the triangle is found. Eventually, when signals received with respect to various PWs are automatically analyzed, an automated optical fiber test is implemented even without a user's separate input.

Referring to FIG. 5, the edge portions of 2D image patterns AR1, AR2 and AR3 as shown in FIG. 4 are emphasized. Such emphasis has an advantage in that it is possible to intensively provide a device user's or tester's sight. The emphasizing of the edge portion may be implemented by the program processing technique of the DSP 370 or the controller 320 in FIG. 3.

Eventually, by emphasizing the shape of a right-angled triangle on the scale domain response as shown in FIG. 5, it is possible to provide the added convenience of interpretation to a user. As such, when in addition to a 2D image visualization technique, specific patterns for optical pulse signals received with respect to various PWs are emphasized and displayed, it is easier for a user to determine and interpret the state of an optical fiber.

FIG. 6 shows an example where the same optical fiber as FIG. 5 is monitored but the width of an available PW is restricted. In order to generate an optical pulse signal having a significantly narrow width and detect a reflected received optical pulse signal, a high-performance transmitter, receiver, and ADC may be needed. Thus, it is assumed that the width of an optical pulse signal that may be used for an optical signal test is restricted due to hardware or cost restrictions. For example, it is assumed that the scale domain response is obtained only with respect to w>1.0 as shown in FIG. 6 and image patterns corresponding to t=25 and t=26 overlap and it is thus difficult to separate them. In this condition, instead of finding a triangle from the scale domain response, a pattern in a vertical direction and a straight-line pattern that has a previously known slope are found.

In FIG. 6, two straight lines AR1 and AR2 corresponding to t=15 meet at a single point on the x-axis that is a time axis. Thus, it is interpreted that the two straight lines AR1 and AR2 correspond to a single point on an optical fiber. On the other hand, since a vertical line corresponding to t=25 and a straight line AR4 having a slope at the right side thereof do not meet at a single point on the x-axis, it is interpreted that they correspond to different points on an optical fiber. As such, since it is possible to separate signals corresponding to two adjacent points on an optical fiber, spatial resolution is improved.

The horizontal axis represents time and the vertical axis represents the size of a pulse width, as in FIGS. 5 and 6.

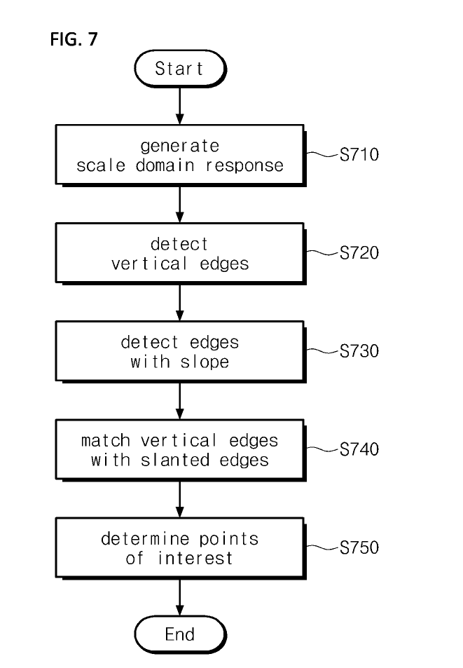

FIG. 7 is an optical fiber monitoring resolution improvement flowchart according to an exemplary embodiment of the inventive concept.

Referring to FIG. 7, the DSP 370 or the controller 320 in FIG. 3 processes digital received optical data to generate a scale domain response for image visualization in step S710. In order to identify signals corresponding to adjacent points on the optical fiber in the case where the scale domain response is restrictively generated, the DSP 370 or the controller 320 detect vertical edges that are perpendicular to the time axis and slanted edges from the patterns of the generated scale domain response through steps S720 and S730.

The DSP 370 or the controller 320 matches the vertical edges and the slanted edges correspondingly on the time axis in step S710.

If the slanted edge corresponding to the vertical edge meets at a single point on the time axis when matching the vertical edges and the slanted edges on the time axis, it is determined through step S750 that the straight line of the vertical edge and the straight line of the slanted edge correspond to a single point on the optical fiber.

On the other hand, if the slanted edge corresponding to the vertical edge does not meet at a single point on the time axis when matching the vertical edges and the slanted edges on the time axis, it is determined through step S750 that the straight line of the vertical edge and the straight line of the slanted edge correspond to different points on the optical fiber.

As such, the exemplary embodiment of the inventive concept may analyze a pattern on the scale domain response from a restricted measurement value to increase optical signal monitoring resolution.

Thus, according to the exemplary embodiment of the inventive concept, it is possible to monitor the whole optical fiber while minimizing a user input by a visualization technique, characteristic-point automatic extraction, and a completely automated monitoring method.

Also, since high spatial resolution may be implemented, there is an advantage in that it is also possible to apply to passive optical network monitoring.

According to the exemplary embodiment of the inventive concept, since the optical fiber is synthetically tested by the using of a plurality of optical pulse signals that has different pulse widths, a user input that is accompanied for an optical fiber test is minimized and the time taken to monitor the whole optical fiber reduces. Also, since spatial resolution that may identify optical signals reflected from adjacent points is high, it is also effectively applied to passive optical network monitoring.

As described above, optimal embodiments are disclosed through the drawings and the present disclosure. Although specific terms are used herein, they are only used for describing the inventive concept and not for limiting meanings or the scope of the inventive concept disclosed in the following claims. Therefore, a person skilled in the art would understand that it is possible to implement various variations and equivalents. For example, components in the drawings have been described as an example, but in other cases, it is possible to alter details by changing, adding or eliminating the components in the drawings accompanied for an optical fiber test without departing from the technical spirit of the present disclosure.

What is claimed is:

1. A method of testing an optical fiber in an optical distribution network, the method comprising:
transmitting, as monitoring light signals, a first optical pulse signal having a first pulse width and a second optical pulse signal having a second pulse width, to an optical fiber connected to optical network units (ONU);
receiving a first received optical pulse signal and a second received optical pulse signal that are reflected through the optical fiber;
generating first and second received optical signals according to received intensities of the first and second received optical pulse signals and then converting the generated signals into first and second digital received optical data; and
processing the first and second digital received optical data to synthetically visualize or analyze optical pulse signals received with a plurality of scales to monitor the optical fiber.

2. The method of claim 1, wherein the first pulse width is wider than the second pulse width.

3. The method of claim 1, wherein the first pulse width is narrower than the second pulse width.

4. The method of claim 1, wherein the first optical pulse signal and the second optical pulse signal are transmitted at different times.

5. The method of claim 1, wherein the first optical pulse signal and the second optical pulse signal are generated by pulse width modulation through a single optical pulse generator.

6. The method of claim 1, wherein the first optical pulse signal and the second optical pulse signal are exclusively generated by different optical pulse generators, respectively.

7. The method of claim 1, wherein the visualization comprises aligning the first and second digital received optical data in a y-axis direction that represents a pulse width, to display the data as a 2D image in a triangle pattern.

8. An apparatus for testing an optical fiber in an optical distribution network, the apparatus comprising:
a transmitter configured to transmit, as monitoring light signals, a first optical pulse signal that has a first pulse width and a second optical pulse signal that has a second pulse width, to an optical fiber connected to optical network units (ONU) through a coupler;
a receiver configured to receive, from the coupler, a first received optical pulse signal and a second received optical pulse signal that are reflected through the optical fiber, and to generate first and second received optical signals according to received intensities of the first and second received optical pulse signals;
an analog to digital (A/D) converter configured to convert the first and second received optical signals into first and second digital received optical data; and
a processor configured to process the first and second digital received optical data to generate a scale domain response for image visualization and optical fiber state analysis to monitor the optical fiber.

9. The apparatus of claim 8, wherein the processor is a digital signal processor that exclusively processes the first and second digital received optical data and is connected to a display that displays the image visualization.

10. The apparatus of claim 8, wherein the transmitter comprises a single optical pulse generator to generate the first optical pulse signal and the second optical pulse signal by pulse width modulation.

11. The method of claim 8, wherein the scale domain response comprises aligning the first and second digital received optical data in a y-axis direction that represents a pulse width, to display the data as a 2D image in a right-angled triangle pattern.

12. A method of testing an optical fiber in an optical distribution network, the method comprising:
transmitting, as monitoring light signals, a plurality of optical pulse signals that has different pulse widths, to an optical fiber connected to optical network units (ONU);
generating a plurality of received optical signals that correspond to received intensities of a plurality of received optical pulse signals reflected through the optical fiber, and then converting the generated signals into digital received optical data;
processing the digital received optical data to generate a scale domain response for image visualization;
detecting vertical edges that are perpendicular to a time axis and slanted edges from patterns of the generated scale domain response, to identify signals corresponding to adjacent points on the optical fiber, even in a case where the scale domain response is restrictively generated; and
matching and analyzing the vertical edges and the slanted edges correspondingly on the time axis to determine whether the signals are at the adjacent points.

13. The method of claim 12, wherein it is determined that a straight line of the vertical edge and a straight line of the slanted edge correspond to a single point on the optical fiber, if the slanted edge corresponding to the vertical edge meets at a single point on the time axis when matching the vertical edges and the slanted edges on the time axis.

14. The method of claim 12, wherein it is determined that a straight line of the vertical edge and a straight line of the slanted edge correspond to different points on the optical fiber, if the slanted edge corresponding to the vertical edge does not meet at a single point on the time axis when matching the vertical edges and the slanted edges on the time axis.

15. An apparatus for testing an optical fiber in an optical distribution network, the apparatus comprising:
a transmitter configured to transmit, as monitoring light signals, a plurality of optical pulse signals that has different pulse widths, to an optical fiber connected to optical network units (ONU) through a coupler;
a receiver configured to receive, from the ONU, a plurality of received optical pulse signals reflected through the optical fiber and generate received optical signals that correspond to received intensities of the plurality of received optical pulse signals;
an analog to digital (A/D) converter configured to convert the received optical signals into digital received optical data; and
a controller configured to process the digital received optical data to generate a scale domain response for image visualization and optical fiber state analysis to monitor the optical fiber, and identify signals corresponding to adjacent points on the optical fiber in a case where the scale domain response is restrictively generated.

16. The apparatus of claim 15, wherein the controller is configured to detect vertical edges that are perpendicular to a time axis and slanted edges from patterns of the generated scale domain response, and match the vertical edges and the slanted edges correspondingly on the time axis, when signals corresponding to adjacent points are identified.
